(19) United States
(12) Patent Application Publication
(10) Pub. No.: US 2007/0044342 A1
(43) Pub. Date: Mar. 1, 2007

(54) Dryer seal

(76) Inventors: John Burns, Simpsonville, SC (US); Kim Van Voorhis, Rutherfordton, NC (US); David Starrett, Greer, SC (US); Steven Mitra, Union, SC (US)

Correspondence Address: JAMES M. ROBERTSON, 233 SOUTH PINE STREET, SPARTANBURG, SC, 29302, US

(21) Appl. No.: 11/494,472

(22) Filed: Jul. 27, 2006

Related U.S. Application Data
(60) Provisional application No. 60/704,396, filed on Aug. 1, 2005.

(51) Int. Cl. F26B 25/00; F26B 11/02

(52) U.S. Cl. 34/242; 34/601

(57) ABSTRACT

A dryer seal utilizing an exterior layer of needle-punched fibrous material in adjoined juxtaposed relation to an interior layer of closed cell foam. The closed cell foam substantially blocks flow through the seal while also providing resiliency to the structure.

### CROSS-REFERENCE TO RELATED APPLICATIONS

This application claims the benefit of U.S. provisional application 60/704,396 filed on Aug. 1, 2005 the contents of which are hereby incorporated by reference in their entirety.

### TECHNICAL FIELD

This invention relates to a dryer seal and more particularly to a dryer seal incorporating a permeability blocking layer disposed in juxtaposed relation to a needle-punched felt to provide substantially reduced permeability across the seal. The permeability blocking layer is preferably a closed cell foam layer or mechanically frothed closed cell foam although non-cellular materials including latex, vinyl, rubber, neoprene, polymeric films, and other coatings are also contemplated. The permeability blocking layer may be infused or treated with a flame retardant chemical composition if desired.

### BACKGROUND OF THE INVENTION

Automatic clothes dryers typically include a housing (also known as a bulkhead) and a rotating drum supported within the housing. It is known to use seal elements in the form of rings of felt which may be disposed between the housing and the drum so as to bear against the drum as it rotates. The use of a sealing element is desirable to prevent air leakage between the drum and the clothes dryer cabinet which could detrimentally affect the air flow system of the dryer. It is known to utilize seals in the form of multi-layered ring structures incorporating a folded over exterior layer such as wool or wool blend nonwoven material with a spacer material such as polyester or polyester blend material held within the folded over exterior. A strip of vinyl or other resilient material may be secured at the surface of the seal to provide resiliency to the seal. This strip of resilient material may also reduce the permeability across the seal.

In the past, it was believed that with proper contact, the seal structures would substantially prevent undesired air flow. Thus, the primary emphasis has been on preventing leakage around the seal. Little emphasis has been directed towards preventing leakage through the seal.

### SUMMARY OF THE INVENTION

According to a potentially preferred embodiment, this invention provides advantages and alternatives over the prior art by providing a dryer seal utilizing an exterior layer of needle-punched fibrous material in adjoined juxtaposed relation to an interior layer of closed cell foam. The layered structure may be folded and seamed to provide a seal geometry as desired. The closed cell foam substantially blocks flow through the seal while also providing resiliency to the structure. The fibrous layer and/or the foam layer may be infused or surface treated with suitable flame retardant agents if desired.

### BRIEF DESCRIPTION OF THE DRAWINGS

The following drawings which are incorporated in and which constitute a part of this specification illustrate an exemplary embodiment of the present invention and, together with the general description above and the detailed description set forth below, serve to explain the principles of the invention wherein:

FIG. 1 is a perspective view of an exemplary clothes dryer with the rotating drum and seal illustrated in phantom;

FIG. 2 is a cut-away view illustrating a cross-section of an exemplary seal mounted around a bulkhead flange of a dryer;

FIG. 3 is a cross-sectional view of the exemplary dryer seal construction illustrated in FIG. 2 incorporating a fibrous felt in juxtaposed relation to a closed cell foam; and

FIG. 4 is a flow chart for an exemplary process for formation of a foam coated seal.

While the invention has been generally described above and will hereinafter be described in connection with certain potentially preferred embodiments and procedures, it is to be understood and appreciated that in no event is the invention to be limited to such illustrated and described embodiments and procedures. On the contrary, it is intended that the present invention shall extend to all alternatives and modifications as may embrace the broad principles of this invention within the true spirit and scope thereof.

### DESCRIPTION

Reference will now be made to the various drawings wherein to the extent possible like reference numerals are utilized to designate corresponding components throughout the various views. Importantly, while the description may refer to an exemplary, representative seal having a given cross-sectional geometry, it is to be understood that reference to this exemplary construction is for illustrative purposes only an that the invention may likewise be applied to seals with any number of other geometries as may be known to those of skill in the art.

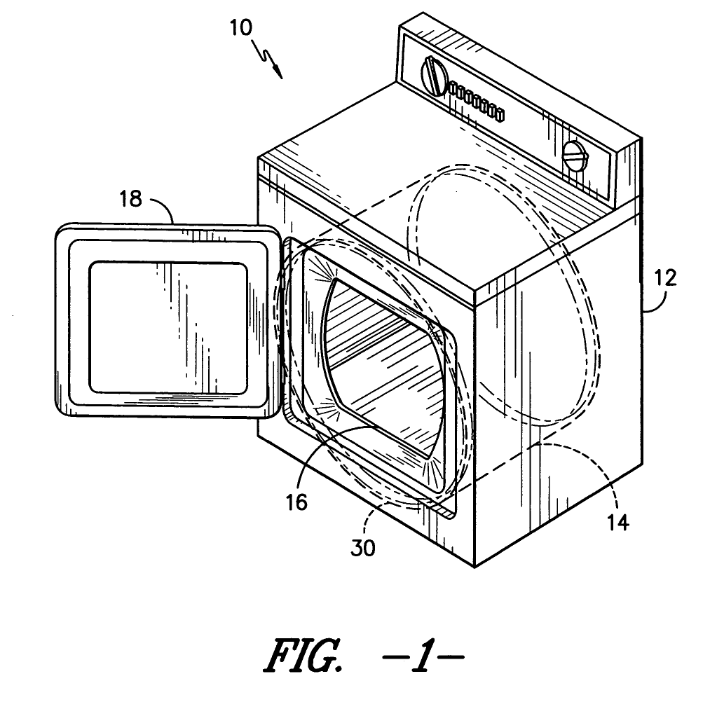

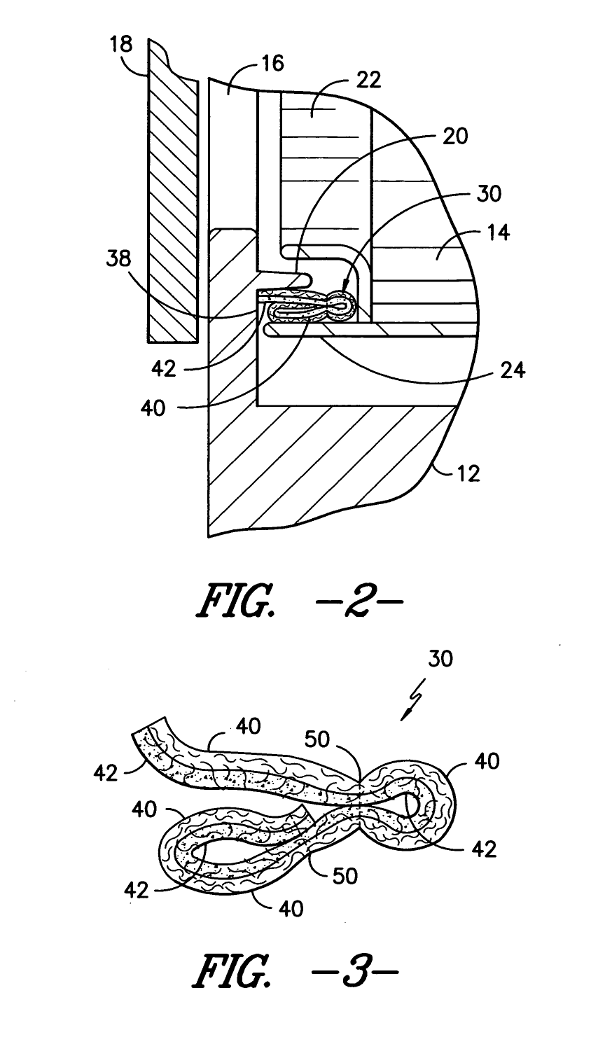

In FIG. 1 there is illustrated a dryer 10 including a cabinet body 12 housing a heated rotating drum 14. As illustrated, the cabinet body includes a door opening 16 for loading clothing articles into the mouth of the drum 14. The door opening 16 may be closed by means of a door 18. As will be well known to those of skill in the art, the cabinet body 12 typically includes a bulkhead flange 20 (FIG. 2) surrounding the door opening and projecting into the interior of the cabinet body. The bulkhead flange 20 is disposed generally around a reduced diameter drum opening 22. An outer wall portion of the drum is disposed in surrounding relation to the flange 20.

As shown, a seal 30 in the form of a ring is held between a portion of the drum 14 and the bulkhead flange 20 to block air flow. As will be appreciated by those of skill in the art, dryers are typically vacuum systems. In operation, the seal 30 prevents the draw of cool (non-heated) air from around the drum. With this flow path blocked, air is drawn more efficiently into the drum from a heated element area for use and eventual vent discharge.

While the actual cross sectional folded geometry of the seal 30 may vary, the layered construction preferably utilizes a fibrous layer 40 such as needle-punched wool blend felt as will be well known to those of skill in the art in overlying juxtaposed relation to a cellular foam layer 42. Exemplary foam materials may include polyurethane foams, latex foams and the like. Importantly, the cellular foam layer is preferably a substantially closed cell foam. In this regard it has been found that closed cell foams provide desired permeability reduction while at the same time retaining substantial resiliency. A mechanically frothed polyurethane foam may be particularly preferred.

According to one potentially preferred practice, it is contemplated that an uncured mechanically frothed polyurethane foam may be deposited in a wet state across the fibrous layer 40 such that a portion of the fibers forming the fibrous layer become embedded within the foam. The foam is then cured in place. Most preferably, a portion of the fibers will extend through the cellular foam layer 42 to the foam surface facing away from the fibrous layer so as to enhance stability across the thickness of the foam layer and to anchor the foam layer 42 in place. Alternatively, it is contemplated that adhesive lamination may be used to join the layers together. If desired, the fibrous layer 40 and/or the foam layer 42 may be infused or surface treated with a suitable flame retardant composition. However, such treatment is not essential to performance.

By way of example only, and not limitation, the fibrous layer 40 may be a non-woven needle punched felt formed from a blend of polyester and wool fibers. In this regard, one potentially preferred blend of fibers in the fibrous layer 40 is about 50 percent mammal generated wool and about 50 percent polyester. However, blends incorporating other materials and/or higher or lower percentages of wool relative to polyester may likewise be utilized. The fibrous layer 40 is preferably characterized by a thickness in the range of about 0.05 inches to about 0.25 inches (most preferably about 0.10 inches) with a mass per unit area of about 5 ounces per square yard to about 25 ounces per square yard (most preferably about 10 ounces per square yard). However, it is likewise contemplated that higher or lower thickness and/or density levels may also be used if desired.

As previously noted, the foam layer 42 is preferably a mechanically frothed substantially closed cell foam of polyurethane. This foam material is preferably applied across the fibrous layer 40 at a coating thickness that is substantially less than the thickness of the fibrous layer 40. Foam layer thickness is preferably about 0.03 inches to about 0.09 inches although greater or lesser thickness levels may be used. By way of example only, for a fibrous layer thickness of about 0.1 inches, a foam layer thickness of about 0.05 inches may be preferred. In this regard it is contemplated that the foam layer will preferably have a thickness in the range of about 20% to about 70% (most preferably about 50%) of the thickness of the fibrous layer 40.

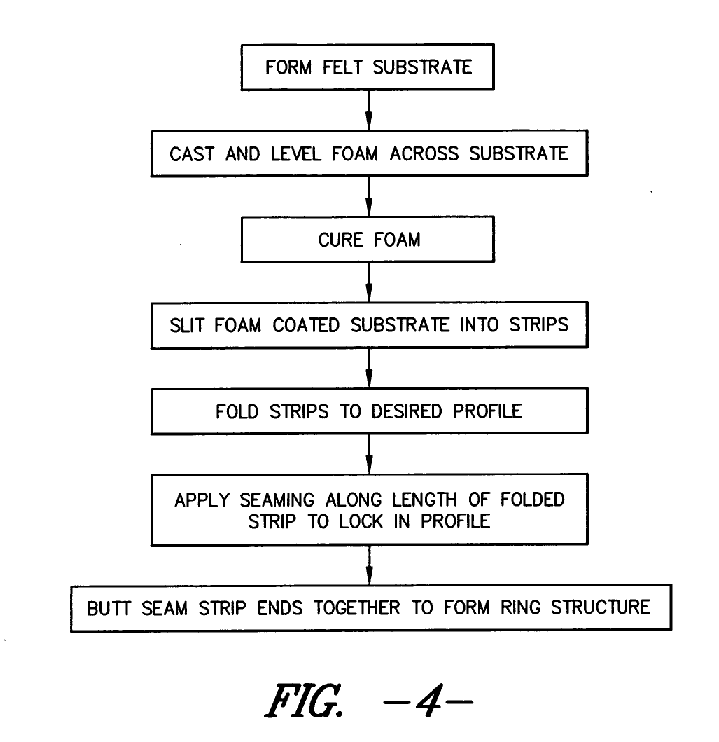

FIG. 4 sets forth an exemplary process for formation of a foam coated seal. As shown, according to the potentially preferred practice the foam is cast across one side of a felt substrate and leveled to a desired thickness. Such application may be carried out by a knife coater or the like. After coating, the foam is typically cured by application of heat such as in an oven or the like. Once the foam is cured, the substrate with the applied foam is cut into strips which are folded into a desired profile. One or more seams 50 (FIG. 3) are then applied along the length dimension of the folded strips so that the desired profile is retained. Such seams are preferably sewn seams using stitch configurations such as chain or lock stitches as will be known to those of skill in the art although other stitch configurations may likewise be utilized if desired. Finally, the ends of the folded strips are joined together to form a ring structure.

Surprisingly, it has been found that seals formed using a felted fibrous layer in combination with a closed cell foam provide dramatically improved air control within the dryer. Moreover, the incorporation of the foam provides a degree of resiliency to the overall ring structure thereby making it possible to reduce or eliminate the use of vinyl strips and other resiliency imparting elements which have been used in the past.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

What is claimed is:

1. A dryer seal comprising an elongate multi-layer structure wherein said elongate multi-layer structure comprises a strip of foam coated fibrous substrate folded upon itself and seamed at least partially along the length dimension to form a predefined cross-sectional profile, wherein the foam coated fibrous substrate consists essentially of a foam layer of mechanically frothed substantially closed cell foam of predefined thickness in juxtaposed contacting relation to a nonwoven felt textile layer comprising a multiplicity of needlepunched fiber elements.

2. The invention as recited in claim 1, wherein the textile layer is characterized by a thickness substantially greater than the foam layer.

3. The invention as recited in claim 1, wherein the textile layer comprises a blend of fibers comprising polyester and mammal generated wool fibers.

4. The invention as recited in claim 3, wherein the blend of fibers comprises at least 50% mammal generated wool fibers.

5. The invention as recited in claim 1, wherein the mechanically frothed substantially closed cell foam is a polyurethane foam.

6. The invention as recited in claim 5, wherein the foam layer is characterized by a thickness of about 0.03 inches to about 0.09 inches.

7. The invention as recited in claim 1, wherein a portion of the needlepunched fiber elements project into and substantially across the foam layer.

8. A dryer seal comprising an elongate multi-layer structure wherein said elongate multi-layer structure comprises a strip of foam coated fibrous substrate folded upon itself and seamed at least partially along the length dimension to form a predefined cross-sectional profile, wherein the foam coated fibrous substrate consists essentially of a foam layer of mechanically frothed substantially closed cell foam of predefined thickness in juxtaposed contacting relation to a nonwoven felt textile layer comprising a multiplicity of needlepunched fiber elements wherein the textile layer comprises a blend of fibers comprising polyester and mammal generated wool fibers and wherein the mechanically frothed substantially closed cell foam is a polyurethane foam and wherein in the cross-sectional profile, the nonwoven felt textile layer defines an exterior contact surface of the seal.

9. The invention as recited in claim 8, wherein the blend of fibers comprises at least 50% mammal generated wool fibers.

10. The invention as recited in claim 8, wherein the mechanically frothed substantially closed cell foam is a polyurethane foam.

11. The invention as recited in claim 8, wherein the foam layer is characterized by a thickness of about 0.03 inches to about 0.09 inches.

12. The invention as recited in claim 8, wherein a portion of the needlepunched fiber elements project into and substantially across the foam layer.
